(19) United States
(12) Patent Application Publication
(10) Pub. No.: US 2004/0161630 A1
(43) Pub. Date: Aug. 19, 2004

(54) Alloys, reflector layers and their use

(75) Inventors: Heiko Specht, Aschaffenburg (DE); Oliver Warkentin, Darmstadt (DE); Torsten Halden, Hammersbach (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: W.C. Heraeus GmbH & Co.KG

(21) Appl. No.: 10/776,792

(22) Filed: Feb. 11, 2004

(30) Foreign Application Priority Data
Feb. 13, 2003 (DE) 103 06 174.6

(51) Int. Cl. B32B 15/01

(52) U.S. Cl. 428/673; 428/688

(57) ABSTRACT

Alloys and reflector layers are provided which are based on silver and which contain at least three different chemical elements. The alloys and reflector layers are used for reflective layers with a reflection factor of over 90% in the visible spectral range of daylight and exhibit a high resistance to atmospheric corrosion relative to chlorine and sulfur.

### BACKGROUND OF THE INVENTION

The invention is directed to alloys and reflector layers, which are based on silver and which contain at least three different chemical elements. The invention is also directed to use of the alloys and the reflector layers.

An alloy made from the metals gold, silver, aluminum, platinum, rhodium, or copper is known from U.S. Pat. No. 4,762,770. Here, a reflector layer is formed either from the pure metals or else from an alloy with these elements. An optical memory layer is arranged over this reflector layer for forming an optical memory disk.

Another alloy made from the metals gold or silver, as well as at least two metals of the group including, among others, platinum, iridium, rhodium, and copper, is known from U.S. Pat. No. 2,947,623.

French Patent FR 922 234 discloses a method for obtaining non-sulfurizable, non-oxidizable and non-destructible silver alloys. Many possible alloy metals, including aluminum, titanium, gold, platinum, other platinum group metals, and silicon are also mentioned, without specifying exact compositions.

German Patent DE 2102980 discloses a silver alloy with only one element from the group including, among others, Al, Si, Ti, and Ta.

Furthermore, alloys for reflective or semi-reflective layers of an optical storage medium are known from U.S. Pat. No. 6,280,811 B1. Here, silver alloys with fractions of iridium, platinum, copper, gold, and rhodium are disclosed.

European published patent application EP 1 213 599 A2 discloses a reflective silver layer, which contains 0.1-3 wt % gold, palladium, or ruthenium, as well as 0.1-3 wt % copper, titanium, chromium, tantalum, molybdenum, nickel, aluminum, niobium, gold, palladium, or ruthenium, wherein the silver layer combines two different metals.

European Patent EP 304 927 B1 discloses a magnetic storage medium with a substrate and a magnetic layer, wherein an intermediate layer between the substrate and the magnetic layer is formed from at least one of the metals of copper, rhodium, palladium, silver, iridium, platinum, gold, aluminum, or tungsten.

European published patent application EP 1 028 421 A2 discloses a multi-layer optical disk with at least two layers for recording data, which are covered by a transparent layer and as well as a light-permeable protective layer. Here, at least one of the two layers for data recording contains at least one element of a group, which includes, among many others, the elements silver, gold, aluminum, copper, ruthenium, rhodium, silicon, titanium, and tantalum.

European Patent EP 304 873 B1 discloses a magneto-optical recording medium with a substrate and alternately arranged cobalt layers and platinum and/or palladium layers as a recording layer. Between the substrate and the recording layer an underlayer is arranged, which consists of at least one element from the group of silver, palladium, rhodium, copper, tungsten, iridium, platinum, and gold.

International application publication WO 99/67084 discloses metal alloys for reflective or semi-reflective layers of an optical storage medium. Here, silver-palladium-copper and silver-palladium-rhodium alloys are mentioned in particular as metal alloys.

European published patent application EP 1 103 758 A2 discloses a reflector layer made from a silver-palladium-copper alloy for a lamp, wherein the palladium content lies in the range of 0.5 to 3 wt %, and the copper content lies in the range of 0.1 to 3 wt %. Furthermore, it is disclosed to provide a sputtering target or a vapor-depositable material from the silver-palladium-copper alloy.

European published patent application EP 1 069 194 A1 discloses a metal alloy for electronic parts with 0.1 to 3.0 wt % palladium, 0.1 to 3.0 wt % copper, and the remainder silver. Furthermore, it is disclosed to use the metal alloy for a sputtering target.

Japanese Patent JP 2000-149327 discloses an optical storage medium with a reflective layer made from silver and alloys from the group of elements tungsten, magnesium, boron, aluminum, gallium, copper, and rhodium.

Furthermore, Japanese published patent application JP 04372738 A discloses an optical recording medium with a reflective layer, which contains, in addition to copper, at least one additional chemical element from the group of Ti, V, Ta, Cr, Mo, W, Mn, Fe, Co, Rh, Ni, Pd, Pt, Ag, Au, Al, N, and O.

Japanese published patent application JP 2002092950 A discloses an optical recording medium with a reflection layer made from silver or a silver alloy with a silver fraction of at least 90%. Information on the other elements making up the silver alloy for the reflection layer is not given.

Japanese published patent application JP 2001256673 A discloses an optical recording medium with a reflection layer, which is formed from Ti, Zr, Ta, Cr, Mo, W, Ni, Rh, Pd, Pt, Cu, Ag, Au, Zn, Al, In, Si, Ge, Te, Sn, Bi, Sb, Ti, or Pt.

Japanese published patent application JP 10228676 A describes an optical recording medium with a first reflection layer, whose composition includes the elements Al, Cu, Ag, Au, Pt, and Pd, wherein the sum of these elements in the composition is ≧65% to ≦95%.

### BRIEF SUMMARY OF THE INVENTION

It is now an object of the invention to provide silver-based alloys, as well as reflector layers, which can be used for reflective layers with a reflection factor of over 90% in the visible spectrum range of daylight and which exhibit a high resistance to atmospheric corrosion relative to chlorine and sulfur. Furthermore, suitable uses for the alloys and reflector layers will be given.

The object is achieved for a first alloy in that the alloy comprises:

0.1 to 3.0 wt % rhenium or rhenium and at least one element of the group including rhodium, platinum, and iridium,

0.1 to 3.0 wt % copper and/or platinum and/or titanium and/or gold and/or aluminum and/or tantalum and/or silicon, and

the remainder silver.

The object is achieved for a second alloy in that the alloy comprises:

0.1 to 3.0 wt % rhodium,

0.1 to 3.0 wt % copper and/or titanium and/or aluminum and/or tantalum and/or silicon, and

≧ about 94 to < about 99 wt % silver.

In particular, an alloy is preferred, which comprises:

0.1 to 3.0 wt % rhodium,

0.1 to 3.0 wt % copper or titanium, and

≧ about 94 to < about 99 wt % silver.

An alloy which has proven especially effective comprises:

about 1 wt % rhodium,

about 1 wt % copper or titanium, and

the remainder silver.

The object is achieved for a third alloy in that the alloy comprises:

0.1 to 3.0 wt % platinum,

0.1 to 3.0 wt % titanium and/or aluminum and/or tantalum and/or silicon, and

the remainder silver.

In particular, an alloy is preferred, which comprises:

0.1 to 3.0 wt % platinum,

0.1 to 3.0 wt % titanium, and

the remainder silver.

An alloy which has proven especially effective comprises:

about 1 wt % platinum,

about 1 wt % titanium, and

the remainder silver.

The object is achieved for a fourth alloy in that the alloy comprises:

0.1 to 3.0 wt % iridium,

0.1 to 3.0 wt % titanium and/or aluminum and/or tantalum and/or silicon, and

the remainder silver.

The object of the invention is achieved for a reflector layer in that this layer comprises:

0.1 to 3.0 wt % rhodium,

0.1 to 3.0 wt % copper and/or titanium and/or aluminum and/or tantalum and/or silicon, and the remainder silver.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a graph in which the reflection (in %) is plotted against wavelength in the visible spectrum for an alloy according to the present invention compared with pure silver and a prior art alloy.

### DETAILED DESCRIPTION OF THE INVENTION

The alloys according to the invention exhibit a reflection factor of over 90% in the visible spectrum range of daylight, wherein simultaneously a high resistance to atmospheric corrosion relative to chlorine and sulfur is achieved.

The resistance to atmospheric corrosion of these alloys was tested by exposing to different climatic tests a thin layer formed by cathode sputtering and also a comparison layer according to the prior art. For example, the following tests were carried out on an alloy according to the invention with 98 wt % silver, 1 wt % rhodium, and 1 wt % copper (Ag98Rh1Cu1):

a) H₂S Corrosive Gas Test

A first comparison layer made of pure silver (Ag100), a second comparison layer with 98 wt % silver, 1 wt % palladium, and 1 wt % copper (Ag98Pd1Cu1), and a third layer made from an alloy according to the invention with 98 wt % silver, 1 wt % rhodium, and 1 wt % copper (Ag98Rh1Cu1) were exposed at a temperature of 25° C. to a corrosive gas with a relative air humidity of 75% and an H₂S content of 1 ppm. The following Table 1 shows the results of the H₂S corrosive gas test:

TABLE 1

| Test period | Ag100 | Ag98Pd1Cu1 | Ag98Rh1Cu1 |
|---|---|---|---|
| 1 h | Clouding | No change | No change |
| 2 h | Noticeable clouding, | lightly yellowish | lightly yellowish |
| | blue tarnish color | tarnish | tarnish |
| 4 h | Noticeable clouding, | yellowish tarnish | yellowish tarnish |
| | blue tarnish color | | |
| 6 h | Completely clouded, | yellowish to | yellowish to |
| | blue tarnish color | brownish tarnish | brownish tarnish |
| 24 h | Completely clouded, | brownish tarnish | brownish tarnish |
| | blue tarnish color | | |

While the Ag100 layer was already cloudy after one-hour of the test period, the corrosion behavior of the Ag98Pd1Cu1 layer, as well as the Ag98Rh1Cu1 layer, is significantly improved and equally good in comparison with each other.

b) Climatic Test:

A comparison layer with 98 wt % silver, 1 wt % palladium, and 1 wt % copper (Ag98Pd1Cu1), and a layer made from an alloy according to the invention with 98 wt % silver, 1 wt % rhodium, and 1 wt % copper (Ag98Rh1Cu1), were exposed to a temperature of 90° C. in air with a relative air humidity of 90% and were evaluated after 4 hr. and also after 24 hr. Here, it was also shown that the corrosion behavior of the Ag98Rh1Cu1 layer is equivalent to that of the Ag98Pd1Cu1 layer.

The reflector layer according to the invention exhibits a reflection factor of over 90% in the visible spectral range of daylight, wherein simultaneously a high resistance to atmospheric corrosion relative to chlorine and sulfur is achieved.

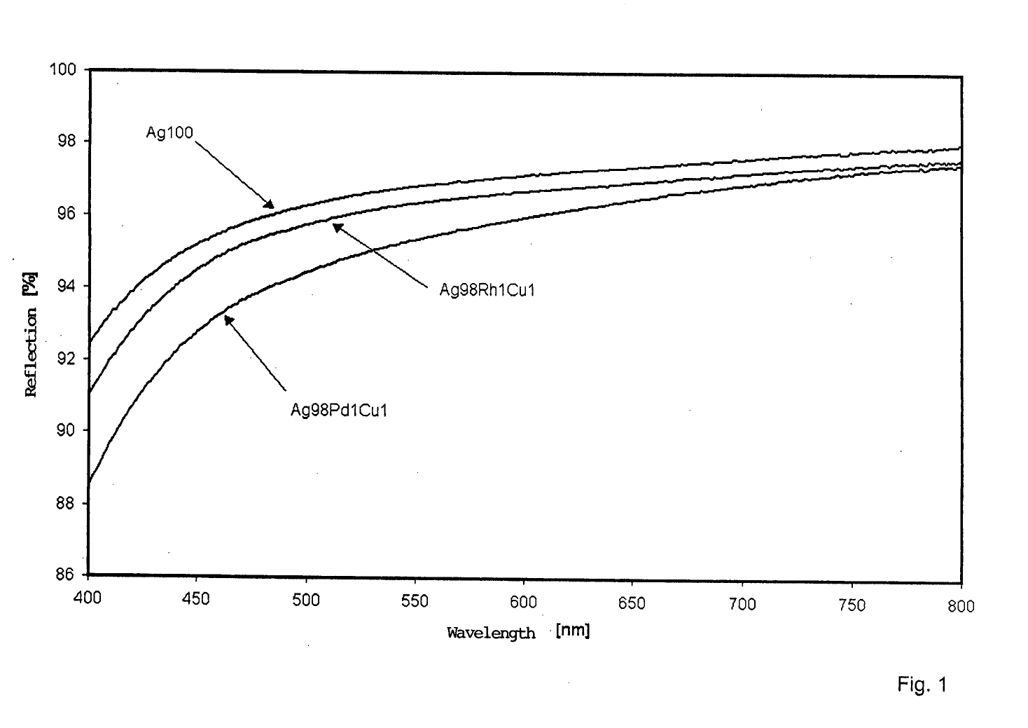

The use of alloys according to the invention for forming reflector layers is ideal. In particular, the alloy Ag98Rh1Cu1 as a reflector layer, relative to known materials for reflector layers, such as Ag98Pd1Cu1, has the advantage of a higher reflection factor. Thus, in a comparison at a wavelength of 560 nm, the Rh-containing alloy had a 77.2% reflection, whereas the Pd-containing alloy had a 70.4% reflection. In FIG. 1 the reflection (in %) of comparison layers made from Ag100 (curve A) and Ag98Pd1Cu1 (curve C) is compared with a layer made from an alloy according to the invention Ag98Rh1Cu1 (curve B) at wavelengths in the range of the visible spectrum. The improved reflection of the layer made from the alloy according to the invention Ag98Rh1Cu1 (curve B) relative to the comparison layer made from Ag98Pd1Cu1 (curve C) is clearly recognized.

However, the electrical conductivity of Ag98Rh1Cu1 is also higher than that of Ag98Pd1Cu1, due to the lower specific resistance of rhodium (4.2 Ωcm) relative to that of palladium (10 Ωcm). There are no discernible differences in corrosion behavior (see above), so that a reflector layer made from an alloy according to the invention represents an excellent alternative to known reflector layers, and it is to be preferred in terms of reflection factors.

In particular, the use of reflector layers for reflection of visible daylight, advantageously in reflective displays, is preferred. Because such displays have no additional electrical background lighting, an especially high reflection factor is necessary here. A layer made from an alloy according to the invention or the reflector layer according to the invention exhibits this high reflection factor to a large degree.

Furthermore, use of the alloys according to the invention as reflector layers or the reflector layer according to the invention is ideal for optical storage media.

In particular, the use of alloys according to the invention for forming an atomization material for cathode sputtering systems has proven effective. After reflector layers for optical storage media and in reflective displays have been formed, usually by PVD (physical vapor deposition), it is helpful to make the alloy available as an atomization material or as a sputter target or as a vaporization material.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An alloy based on silver and containing at least three different chemical elements, the alloy comprising:
0.1 to 3.0 wt % Re or Re and at least one element selected from the group consisting of Ir, Rh, and Pt;
0.1 to 3.0 wt % of at least one element selected from the group consisting of Cu, Pt, Ti, Au, Al, Ta, and Si; and
the remainder silver.

2. An alloy based on silver and containing at least three different chemical elements, the alloy comprising:
0.1 to 3.0 wt % Rh;
0.1 to 3.0 wt % of at least one element selected from the group consisting of Cu, Ti, Al, Ta, and Si; and
≧ about 94 to < about 99 wt % silver.

3. The alloy according to claim 2, wherein the alloy comprises:
0.1 to 3.0 wt % Rh;
0.1 to 3.0 wt % Cu or Ti; and
≧ about 94 to < about 99 wt % silver.

4. The alloy according to claim 3, wherein the alloy comprises:
about 1 wt % Rh;
about 1 wt % Cu or Ti; and
the remainder silver.

5. An alloy based on silver and containing at least three different chemical elements, the alloy comprising:
0.1 to 3.0 wt % Pt;
0.1 to 3.0 wt % of at least one element selected from the group consisting of Ti, Al, Ta, and Si; and
the remainder silver.

6. The alloy according to claim 5, wherein the alloy comprises:
0.1 to 3.0 wt % Pt;
0.1 to 3.0 wt % Ti; and
the remainder silver.

7. The alloy according to claim 6, wherein the alloy comprises:
about 1 wt % Pt;
about 1 wt % Ti; and
the remainder silver.

8. An alloy based on silver and containing at least three different chemical elements, the alloy comprising:
0.1 to 3.0 wt % Ir,
0.1 to 3.0 wt % of at least one element selected from the group consisting of Ti, Al, Ta, and Si; and
the remainder silver.

9. A reflector layer based on silver and contain at least three different chemical elements, the reflector layer comprising:
0.1 to 3.0 wt % Rh;
0.1 to 3.0 wt % Cu, Ti, Al, Ta, and Si; and
the remainder silver.

10. The reflector layer according to claim 9, wherein the reflector layer comprises:
0.1 to 3.0 wt % Rh;
0.1 to 3.0 wt % Cu or Ti; and
the remainder silver.

11. The reflector layer according to claim 10, wherein the reflector layer comprises:
about 1 wt % Rh;
about 1 wt % Cu or Ti; and
the remainder silver.

12. The reflector layer according to claim 9, wherein the reflector layer reflects visible daylight.

13. The reflector layer according to claim 12, wherein the reflector layer is part of a reflective display.

14. The reflector layer according to claim 9, wherein the reflector layer is part of an optical storage medium.

15. The alloy according to claim 1, wherein the alloy forms a reflector layer.

16. The alloy according to claim 15, wherein the reflector layer reflects visible daylight.

17. The alloy according to claim 16, wherein the reflector layer is part of a reflective display.

18. The alloy according to claim 15, wherein the reflector layer is part of an optical storage medium.

19. The alloy according to claim 1, wherein the alloy comprises a sputtering material for cathode sputtering systems.
